(19) United States
(12) Patent Application Publication
(10) Pub. No.: US 2004/0165677 A1
(43) Pub. Date: Aug. 26, 2004

(54) Method and system to efficiently modulate data while reducing DC drift

(76) Inventors: Sheng Shen, Marlborough, MA (US); Weimin Sun, Westborough, MA (US); Bo Zhang, Boxborough, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/373,229

(22) Filed: Feb. 24, 2003

(51) Int. Cl. H04L 25/34

(52) U.S. Cl. 375/290; 375/296

(57) ABSTRACT

A method and system of reducing inter symbol interference (ISI) in a multibit symbol modulation scheme. Adjacent symbol pulses are forces to have opposite polarities. Additional phase slots are added to the symbol to modulate any bits lost because amplitude modulation cannot be used. The width of the phase slots is reduced as a result of reduced DC drift and, therefore, ISI.

### BACKGROUND

1. Field

The embodiments of the invention relate to modulation. More specifically, embodiments of the invention relate to modulation scheme having reduced DC drift.

2. Background

Many modulation schemes use amplitude modulation (AM) to encode data and symbols. Frequency and pulse width modulation may also be used in connection with AM to increase the encoding efficiency. AM may take one of two forms. Return to zero (RZ) or non-return to zero (NRZ) AM. In either case, for example, a data bit corresponding to “zero” may be mapped to one amplitude level and the data bit corresponding to “one” mapped to another amplitude level. Thus, a long string of data bits of the same value result in a series of pulses having the same amplitude. This causes DC drift on the physical channel. DC drift has an adverse impact on the signal quality of the receiver and aggravates ISI (inter symbol interference) to alleviate the negative effects of DC drift the data is often scrambled using eight bit/ten bit (8b/10b) encoding. A resulting data stream has evenly distributed 1's and 0's after the encoding. Unfortunately, twenty percent of the physical bandwidth may not be effective when the underlying modulation is not binary.

### BRIEF DESCRIPTION OF THE DRAWINGS

FIG. 1 is a diagram showing a generalized format of a symbol of one embodiment of the invention.

FIG. 2 is a diagram showing the modulation elements of symbol of one embodiment of the invention that encodes eight databits.

FIGS. 3a-3e are diagrams of possible symbols to encode eight bits per symbol in accordance with modulation elements discussed in connection with FIG. 2.

FIGS. 4a-4e show symbol wave forms of symbol scrambled symbols analogous to those shown in FIGS. 3a-3e.

FIG. 5 is a block diagram of a modulator of one embodiment of the invention.

FIG. 6 is a block diagram of a demodulator in one embodiment of the invention.

FIG. 7 is a block diagram of the system incorporating one embodiment of the invention.

### DETAILED DESCRIPTION

Rather than scrambling data, embodiments of the invention scramble pulses of the symbols. The scrambling of the symbol pulses prevents modulation of bits using amplitude modulation. Therefore, additional phase slots are introduced to accommodate the number of bits lost by the lost of amplitude modulation. However, the improved modulation permits reduced size phase slots and shorter gap widths. Thus, efficiency over traditional 8b/10b encoding may be achieved. A plural bit symbol modulation scheme, referred to herein as IDP modulation is described in copending application Ser. No. ______ entitled, SYSTEM AND METHOD OF EFFICIENTLY MODULATING DATA USING SYMBOLS HAVING MORE THAN ONE PULSE, filed Feb. 18, 2003 and assigned to the assignee of the instant application. Symbol scrambling will be explained in the context of IDP modulation. However, it should be recognized that other embodiments of the invention may be used with other plural pulse symbol modulation schemes. Embodiments of the invention may also be used with single pulse symbols that encode more than one bit.

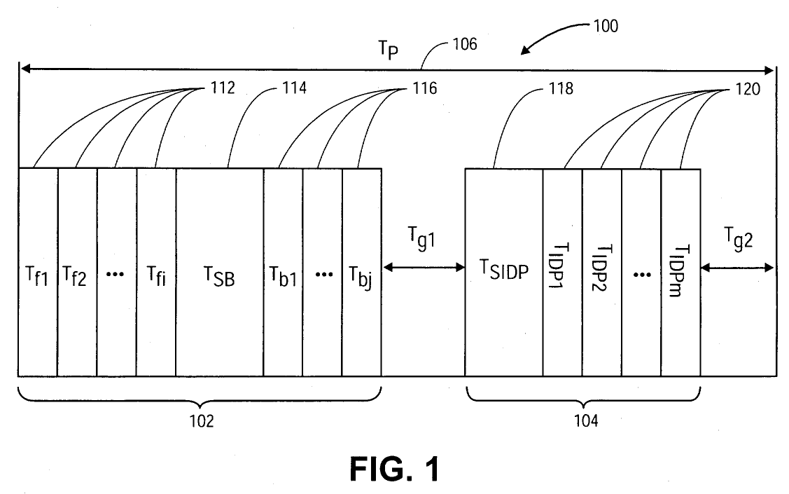

FIG. 1 is a diagram showing a generalized format of a symbol of IDP modulation. The symbol 100 occurs within a symbol period (T_{P}) 106. The symbol includes a first pulse 102 alternatively referred to as a basic pulse 102 and N additional pulses 104. In FIG. 1 N is equal to one, however, N could be any positive integer. Additional pulses are alternatively referred to herein as IDP pulses 104.

The basic pulse 102 includes i leading slots 112, where i is a positive integer, a base pulse 114 and j lagging slots 116, where j is also a positive integer. The IDP pulse 104 includes a base pulse 118 and m lagging slots where m is a positive integer. Notably, i, j and m are not necessarily equal. In FIG. 1, T_{fx} is the width of a leading slot 112, T_{bx}is a width of the lagging slot 116 (alternatively referred to as front end slots and back end slots respectively) of the basic pulse 102 and T_{IDP} is a width of the lagging slot 120 of the IDP pulse 104. The slot width between leading slots and lagging slots and between the pulses may not be equal.

T_{SB} is the width of the base pulse 114 of the basic pulse 102. T_{IDP} is the width of the base pulse 118 of the IDP pulse. T_{SB} and T_{SIDP} are selected in one embodiment to be the minimum pulse that can be properly propegated along the communication channel without the necessity of channel compensation such as equalization. The basic pulse 102 is separated from the IDP pulse 104 by a gap with T_{g1}.

If additional IDP pulses are present within the symbol period, they will each be separated from their predecessor by a gap. It is not necessary that all additional pulse have a same format. As used herein, format refers to the base pulse and lagging slots. Thus, a same format has an equal number and equal size of slots and a same width base pulse. Thus, where mₓ≠m_{y} a different format exists, where x & y refer to distinct additional pulses. A final gap occurs after the last IDP pulse 104, in this case, having a gap width T_{g2}. Amplitude modulation (AM) can be used separately on each pulse. This provides two bits of modulation (one per pulse) if return to zero (RZ) AM is used or four bits of modulation (two per pulse) if non return to zero (NRZ) AM is used.

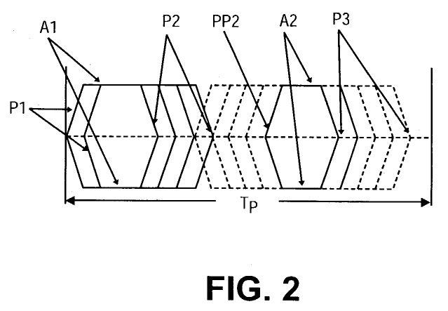

FIG. 2 is a diagram showing the modulation elements of a symbol of one embodiment IDP modulation that encodes eight data bits. P1 is the possible starting position of the front edge of the basic pulse. A1 is the possible polarization of the basic pulse. P2 is the possible back edge position of the basic pulse. PP2 is a possible starting position of the base pulse of the IDP pulse. A2 is the possible polarization of the IDP pulse. P3 is the possible position of the back edge of the IDP pulse. In this case, referring back to the nomenclature of FIG. 1, i equals 1, j equals 3 and m equals 4.

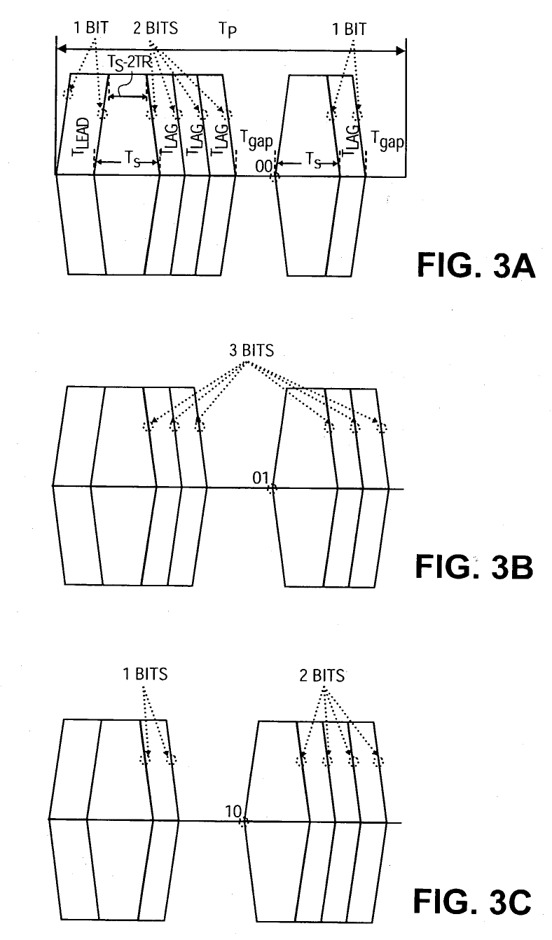

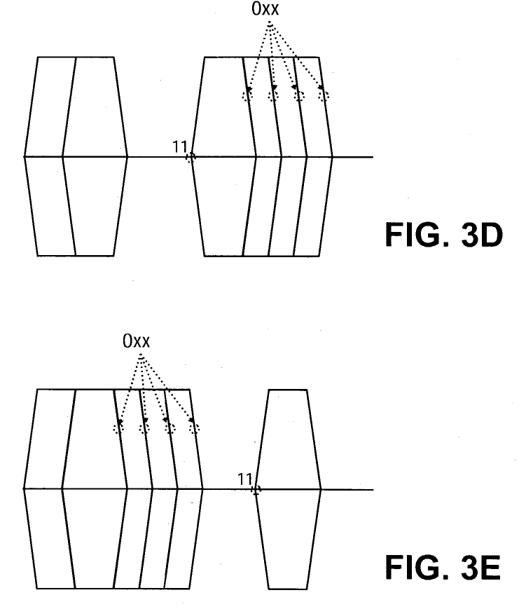

FIGS. 3a-3e are diagrams of possible symbols to encode eight bits per symbol in accordance with modulation elements discussed in connection with FIG. 2. As can be seen, the relative position of the base pulse of the IDP pulse varies within the symbol period. This variance of the position of the base pulse of the IDP pulse encodes at least one bit, and in this example, two bits of data. Stated slightly differently, the relationship between the pulses improves modulation efficiency. The position the IDP pulse may assume depends on the duration of the basic pulse. The IDP pulse is thus moveable within the symbol period T_{P}. Conversely, in one embodiment, the location of the base pulse of the basic pulse is fixed within T_{P}.

In this 8-bit modulation example, two bits are associated with the amplitude modulation (one for basic pulse the other for IDP pulse). This assumes RZ AM. One bit is modulated by the front edge of basic pulse. Five bits are modulated by the combinations of the basic pulse and the IDP pulse. In FIG. 3a, two bits are modulated by the back edge of basic pulse and one bit is modulated by back edge of IDP pulse, which yields eight possible states. In FIG. 3b, the combination of basic pulse's back edges (three edge positions) and the IDP pulse's back edges (three edge positions) results in total of nine states. FIG. 3c yields eight states, similar to FIG. 3a. FIGS. 3d, e provide an additional eight possible states. The total combinations for FIGS. 3a-e, provide more than 32 states for five bits of modulation. These states are addressed further below in connection with Tables 6-10.

Tables 1 through 5 show one possible mapping of the data to the symbols shown in FIGS. 3a-3e respectively.

TABLE 1

| | |
|---|---|
| D0 | A1 (1 = HIGH, 0 = LOW) |
| D1 | P1 (0 = edge_0, 1 = edge_1) |
| D2 = 0 | PP2 |
| D3 = 0 | PP2 |
| D4 | P2 |
| D5 | P2 |
| D6 | A2 (1 = HIGH, 0 = LOW) |
| D7 | P3 |

TABLE 2

| | |
|---|---|
| D0 | A1 (1 = HIGH, 0 = LOW) |
| D1 | P1 (0 = edge_0, 1 = edge_1) |
| D2 = 1 | PP2 |
| D3 = 0 | PP2 |
| D4 | P2 & P3 |
| D5 | P2 & P3 |
| D6 | P2 & P3 |
| D7 | A2 (1 = HIGH, 0 = LOW) |

TABLE 3

| | |
|---|---|
| D0 | A1 (1 = HIGH, 0 = LOW) |
| D1 | P1 |
| D2 = 0 | PP2 |
| D3 = 1 | PP2 |
| D4 | P2 |
| D5 | A2 (1 = HIGH, 0 = LOW) |
| D6 | P2 |
| D7 | P3 |

TABLE 4

| | |
|---|---|
| D0 | A1 (1 = HIGH, 0 = LOW) |
| D1 | P1 |
| D2 = 1 | PP2 |
| D3 = 1 | PP2 |
| D4 = 0 | P2 |
| D5 | A2 (1 = HIGH, 0 = LOW) |
| D6 | P3 |
| D7 | P3 |

TABLE 5

| | |
|---|---|
| D0 | A1 (1 = HIGH, 0 = LOW) |
| D1 | P1 |
| D2 = 1 | PP2 |
| D3 = 1 | PP2 |
| D4 = 1 | P3 |
| D5 | P2 |
| D6 | P2 |
| D7 | A2 (1 = HIGH, 0 = LOW) |

One of ordinary skill will recognize that various other mappings are possible. Referring again to FIGS. 3a-e, in one embodiment of IDP, the symbol period, TP is 2000 ps. T_{LEAD} (width of the leading slot) is 160 ps, rise time is 70 ps, Tₛ, is 300 ps T_{LAG} (width of the lagging slot for both pulses) is 160 ps, and the gap width T_{gap} is 300 ps.

As previously noted in embodiments of the invention, adjacent pulses within a symbol are forced to have opposite polarities independent of the data they encode. The net result is that amplitude modulation is not possible. Thus, to encode the data in a scrambled symbol, additional phase slot(s) must be added. In the case of RZ AM for two pulse symbol (as described with reference to FIGS. 3a-3e above) three phase slots must be added to encode the two amplitude modulation bits. Where only a single pulse symbol using RZ AM is used, a single additional phase slot can be used to encode the amplitude modulation bit. As used herein, “amplitude modulation bit” refers to a bit of data that would be encoded using amplitude modulation in the absence of this scrambling. For example, referring to Table 1, D0 and D6 are amplitude modulation bits. This can be seen with reference to the other tables. The amplitude modulation bit within a data segment would vary with the encoding. In this manner, the amplitude modulation element is replaced with a phase modulation element.

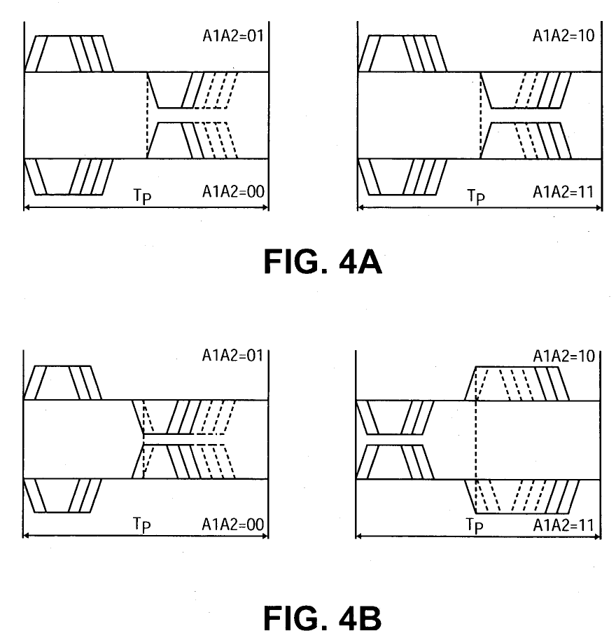

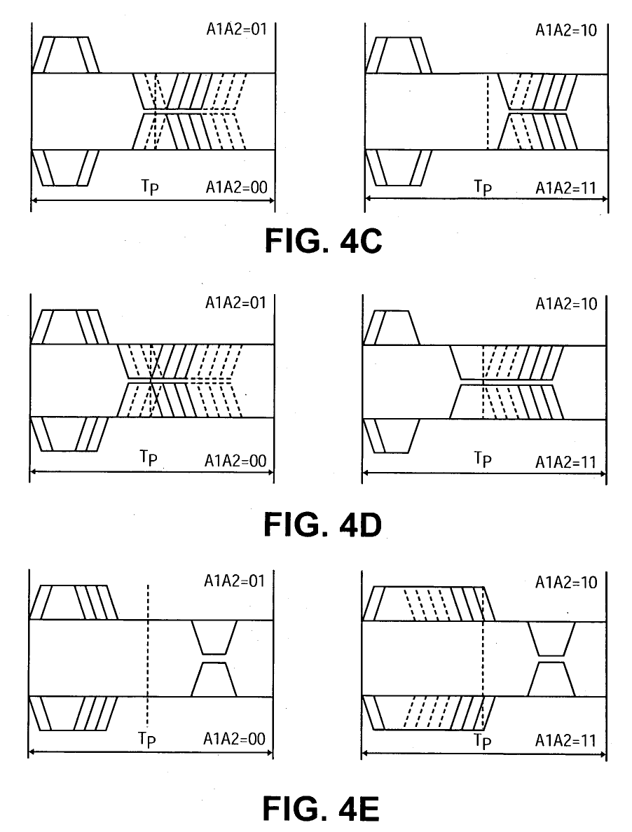

FIGS. 4a-4e show symbol wave forms of symbol scrambled symbols analogous to those shown in FIGS. 3a-3e. In each case, the symbol wave form is shown mapping to each possible value of A1 and A2. While in principle, it would appear that the addition of three phase slots would significantly expand the symbol. For example, using the numbers above, three additional phase slots at 160 ps per slot would expand the symbol period from 2000 ps to 2480 ps per eight bit symbol. This effectively causes an expansion of the symbol period. However, the reduction of DC drift and ISI permits the scrambled symbols to use narrow phase slots, narrow gaps and narrow base pulses. As used herein, “narrow” when referring to phase slots, base pulses and gaps, refers to a phase slot (base pulse or gap) having a width that is shorter than would be permissible or unequalized channel in the absence in the symbol scrambling. The effect of the scrambling that permits use the narrow symbol elements as explained below, which reduces the symbol period.

Simulations have demonstrated that this symbol scrambling reduces inter symbol interference and DC drift such that a narrower phase slot may be used and still achieve recognition of the data encoded. This is because the maximum number of symbol pulses in a row that may have the same polarity is two. This occurs in the IDP example where the second pulse of a first symbol has the same polarity as the first pulse of its successor symbol. Conversely, in unscrambled IDP, an arbitrarily large number of pulses in a row may have the same polarity depending on the data. The simulation used above describes timing with four sets of data. The first set used eight consecutive positive wide width pulses followed by a negative narrow width pulse. The third set used eight scramble IDP pulses followed by a symbol of the same polarity as the proceeding ending pulse. The fourth set used eight scrambled IDP pulses followed by a symbol of the opposite polarity as the proceeding ending pulse.

In the above example, simulations reflect that 30 ps may be saved per slot. A narrower base pulses and narrower gap widths are also enabled. There are twelve slots as can be seen with reference to FIG. 2. Thus, the total time saving per symbol period using symbol scrambling in the simulation was 360 ps. This does not include any possible savings from reducing the gap width or base pulse width. Accordingly, 2480−360 ps saved results in the 2120 ps symbol period. 2000 ps divided by 2120 ps indicates an efficiency of the symbol scrambled solution of 94.3% which compares favorably to the 80% efficiency achieved with the 8 bit/10 bit encoding and no data bit scrambling or rearrangement is required.

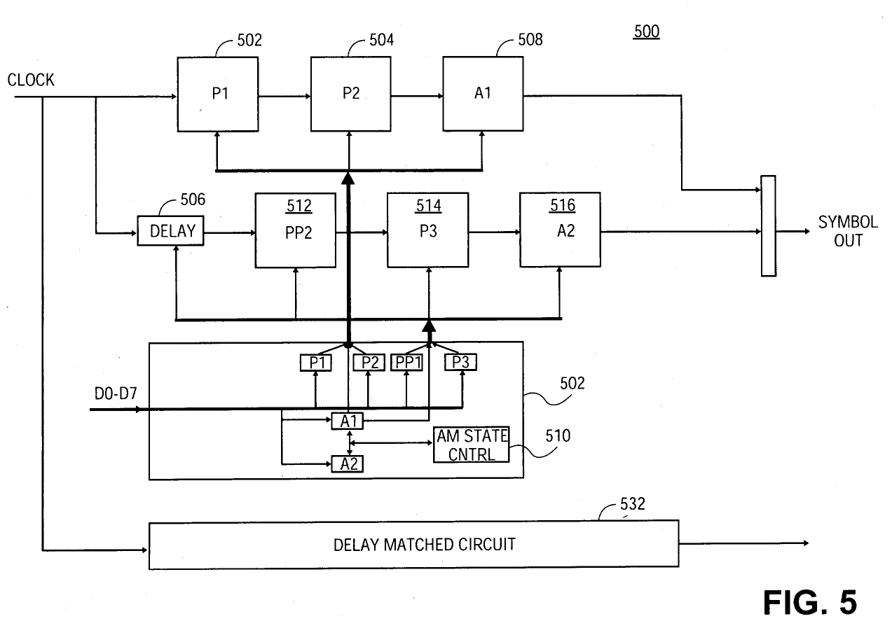

FIG. 5 is a block diagram of a modulator of one embodiment of the invention. Data is supplied to mapping unit 502 which maps the data to the modulation elements using the same scheme as FIG. 2. AM state control 510 controls the influence of the amplitude modulation bits on the first and second pulse of the symbol created. Logic P1, P2 and A1 generate the first pulse responsive to the clock under the control of mapping unit 502. Delay unit 506 insures that the second pulse is delayed relative to the first pulse by delaying the clock to logic units 512, 514 and 516. Those logic units generate the second pulse of the symbol under control of mapping unit 502. Delay matched circuit 532 insures that the forwarded clock is consistent with the symbol out.

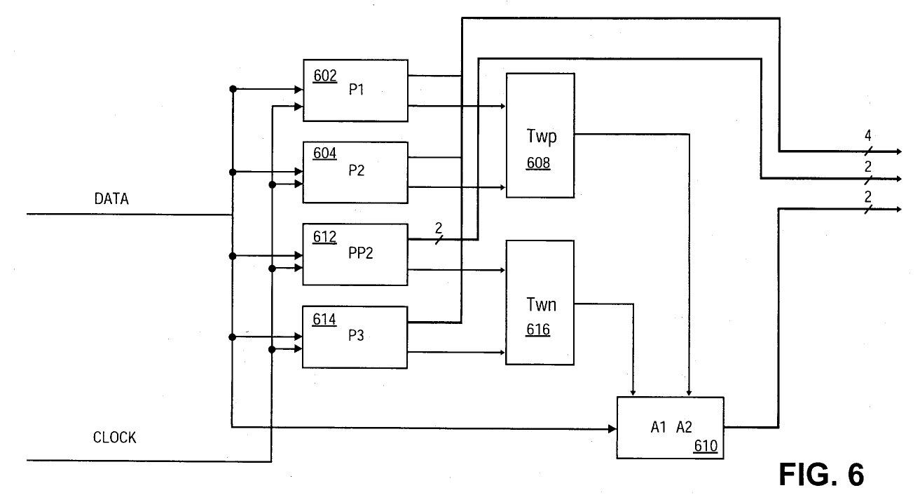

FIG. 6 is a block diagram of a demodulator in one embodiment of the invention. Logic block 602 decodes modulation element P1 to recover one bit of data. Logic block 604 in conjunction with logic block 606 decodes modulation element P2 and P3 respectively to collectively yield three additional bits of data. Logic block 605 decodes modulation mode PP2 to recover the two bits of data encoded in the position of the IBP pulse. Logic blocks 608 and 616 decode the pulse widths of the first and second pulse respectively. Logic block 610 decodes the incoming symbol to recover the amplitude modulation bits.

While the foregoing description was in connection with two pulse symbol, embodiments of the invention can be expanded to N pulses where as an arbitrarily large integer. For example, where N equals three, two pulses in the period would have the same polarity, but no two adjacent pulses within the symbol period would have the same polarity. Additionally, in one embodiment of the invention, single pulse symbols may be employed. In such an embodiment, a single narrow phase slot is added to each symbol and alternating polarity may be achieved by, for example, triggering on the clock edges such as that, for example, a symbol triggered by a rising edge would have positive polarity while a symbol triggered by a falling edge would have negative polarity. Other ways of insuring alternate polarity would occur to one of ordinary skill in the art.

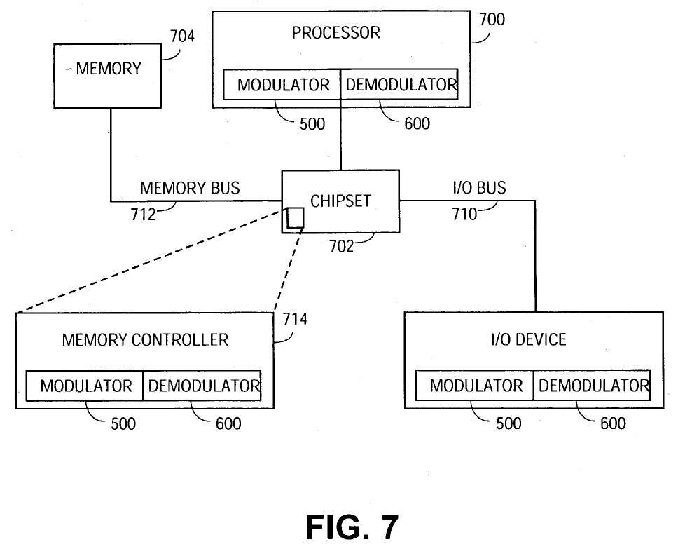

FIG. 7 is a block diagram of the system incorporating one embodiment of the invention. The processor 700 includes a modulator 500 and demodulator 600. By insuring that adjacent pulses within a symbol period, or adjacent pulses generally, have different polarities, DC drift within the communication channel can be substantially reduced. By controlling ISI in the manner, narrow phase slots may be employed by the modulator encoding data. Thus, improving modulation efficiently over existing data scrambling technique. The processor is coupled to a chip set 702 which is coupled to a memory bus 612 and an I/O bus 710. The chip set includes a memory controller 714 which also includes a modulator 500 and a demodulator 600. The memory controller interacts with the memory 604 over memory bus 712. In such an embodiment, the memory interface may include a modulation 500 and demodulator 600. An I/O device 706, which also contains a modulator 500 and a demodulator 600, is coupled to I/O bus 710 and may receive symbols modulated as previously described such that adjacent pulses within the symbol period have opposite polarities. The I/O device may include, for example, a disk controller.

In the foregoing specification, the invention has been described with reference to specific embodiments thereof. It will, however, be evident that various modifications and changes can be made thereto without departing from the broader spirit and scope of embodiments of the invention as set forth in the appended claims. The specification and drawings are, accordingly, to be regarded in an illustrative rather than a restrictive sense.

What is claimed is:

1. A method comprising:
defining a modulation symbol to have a first pulse of a first polarity and a second pulse of an opposite polarity, the second pulse adjacent to the first pulse within the symbol;
expanding a symbol period to accommodate a plurality of additional phase slots one of the first pulse and the second pulse; and
reducing a symbol period by reducing a time for each phase slot on the first and second pulses.

2. The method of claim 1 further comprising:
replacing an amplitude modulation element with a phase modulation element corresponding to the additional slots.

3. The method of claim 1 comprising:
encoding a plurality of data bits in the modulation symbol without rearranging the data bits.

4. A system comprising:
a processor including a modulator, the modulator to encode data into a symbol comprising a plurality of pulses, such that adjacent pulses of the symbol have an amplitude of opposite polarity;
a bus coupled to the processor; and
an input output (I/O) device coupled to the bus, the I/O device including a demodulator to recover the data.

5. The system of claim 4 wherein the modulator encodes an amplitude modulation element in an additional phase slot added to at least one pulse of the symbol.

6. The system of claim 4 wherein the modulator encodes data with at least 90% efficiency.

7. The system of claim 4 wherein the data is not scrambled for encoding.

8. A method comprising:
encoding a plurality of data bits as a symbol having a plurality of pulses with adjacent pulses of the symbol having different polarities independent of the data bits encoded; and
transmitting the symbol on a communication channel.

9. The method of claim 8 wherein encoding comprises:
providing by a plurality of narrow phase slots including at least one additional narrow phase slot to modulate an amplitude modulation bit; and
mapping the amplitude modulation element to the additional narrow phase slot.

10. The method of claim 8 wherein encoding comprises:
establishing a gap size between pulses at a smaller size made possible by reduced inter symbol interference due to alternating polarity.

11. A symbol comprising:
a first pulse having a polarity and a plurality of phase slots; and
a second pulse having an opposite polarity independent of the data encoded and a plurality of phase slots wherein a minimum size of the phase slots is reduced relative to symbols having adjacent pulse of a same polarity.

12. The symbol of claim 11 further comprising:
additional phase slots added to one of the first pulse and the second pulse to encode at least one amplitude modulation bit.

13. The symbol of claim 11 further comprising:
at least one additional pulse with each additional pulse having a polarity different from its predecessor.

14. The symbol of claim 11 wherein the first pulse is separated from the second pulse by a gap, having a size and wherein a minimum gap size is smaller than a minimum gap size for symbols permitting adjacent pulses of a same polarity.

15. A method comprising:
generating a plurality of single pulse symbols each symbol to encode a plurality of data bits the symbols having a plurality of narrow phase slots including at least one additional narrow phase slot to encode an amplitude Sheng
forcing adjacent symbols to have opposite polarities independent of data bits encoded.

16. The method of claim 15 further comprising:
separating the adjacent symbols by a gap having a size less than a minimum size permitted if the adjacent symbols are permitted to have a same polarity.

17. The method of claim 15 further comprising:
transmitting the plurality of pulses over a communication channel; and
decoding the symbols to retrieve the data bits.
